(19) United States
(12) Patent Application Publication
(10) Pub. No.: US 2025/0085542 A1
(43) Pub. Date: Mar. 13, 2025

(54) Transparent Structure With Holographic Element

(71) Applicant: Pittsburgh Glass Works, LLC, Cheswick, PA (US)

(72) Inventor: Kyle Fragassi, Cheswick, PA (US)

(21) Appl. No.: 18/882,942

(22) Filed: Sep. 12, 2024

Related U.S. Application Data
(60) Provisional application No. 63/538,110, filed on Sep. 13, 2023.

(51) Int. Cl. G02B 27/01; B60K 35/231; G03H 1/02

(52) U.S. Cl. CPC G02B 27/0103; B60K 35/231; G03H 1/0252; B60K 2360/785; G02B 2027/0105; G03H 2001/0212; G03H 2250/12

(57) ABSTRACT

An article includes a first transparent structure having an interior surface and an exterior surface opposite the interior surface and a holographic film positioned adjacent to one of the interior surface or the exterior surface.

### CROSS-REFERENCE TO RELATED APPLICATION

The present application is claims priority to, and is a non-provisional of, United States Provisional Patent Application No. 63/538,110, filed Sep. 13, 2023, the disclosure of which is hereby incorporated by reference in its entireties.

### BACKGROUND OF THE INVENTION

### Field

The present application relates generally to transparent articles and, more specifically, to automotive glass articles having holographic elements.

### Technical Considerations

Holographic elements are useful in automotive glass articles, particularly windshields, sidelights, and rear windows, for projecting messages and images onto the automotive glass articles. Drawbacks to conventional designs include susceptibility to damaging the integrity of the holographic film, control of the projection average angle, and control of light absorption.

Accordingly, those skilled in the art continue research and development in the field of glass articles, and more particularly, to automotive glass articles having holographic elements.

### SUMMARY OF THE INVENTION

The invention relates to articles having at least one holographic element.

In one example, the article includes a first transparent structure having an interior surface and an exterior surface opposite the interior surface and a holographic film positioned adjacent to one of the interior surface or the exterior surface. The first transparent structure may include a polymer or glass. The article may include a second transparent structure having an interior surface and an exterior surface opposite the interior surface, the interior surface positioned adjacent to the holographic film and opposed from the first transparent structure.

The first transparent structure may be a first glass substrate comprising a No. 1 surface and a No. 2 surface opposite the No. 1 surface. The second transparent structure a second glass substrate opposed from the first glass substrate, wherein the second glass substrate includes a No. 3 surface that faces towards the No. 2 surface, and a No. 4 surface opposite the No. 3 surface. The holographic film may be positioned between the first glass substrate and the second glass substrate.

The article may further include a light source. In one example, the light source is positioned adjacent to the first transparent structure. In one example, the light source is positioned adjacent to the interior surface of the first transparent structure. In another example, the light source is positioned adjacent to the interior side of the second transparent structure. In another example, the light source is positioned between the first transparent structure and the second transparent structure. The light source may include a plurality of LEDs or a LIDAR system.

In one embodiment, the article includes a first transparent structure having an exterior facing No. 1 surface and an interior facing No. 2 surface opposite the No. 1. The article further includes a second transparent structure having an exterior facing No. 3 surface that is opposite and facing the No. 2 surface, and an interior facing No. 4 surface that is opposite the No. 3 surface. A holographic film is positioned adjacent either to the No. 2 surface or the No. 3. The article further includes an interlayer. The interlayer may be positioned between the No. 2 surface and the holographic film, between the No. 3 surface and the holographic film, or between the No. 2 surface and the No. 3 surface and comprises and opening being configured to receive the holographic film.

In another embodiment, the article may further include two of the following: (1) a first interlayer positioned between the No. 2 surface and the holographic film, and/or (2) a second interlayer positioned between the No. 3 surface and the holographic film, and/or (3) a middle interlayer having an opening configured to receive the holographic film.

In another embodiment, the articles may further include all three of the following: first interlayer positioned between the No. 2 surface and the holographic film, and/or (2) a second interlayer positioned between the No. 3 surface and the holographic film, and/or (3) a middle interlayer having an opening configured to receive the holographic film.

The holographic film may be coupled with the interior surface of the first transparent structure. The holographic film may be configured to receive light at an average receiving angle and reflect the light at an average projection angle that is offset from the average receiving angle. The average receiving angle may be substantially perpendicular to the holographic film. The article may be an automotive component, such as a windshield, a rear window, a brake light, or a headlight.

Also disclosed are systems for directing light through an article.

In one example, the system includes a light source and an article positioned relative to the light source, the article having a first transparent structure having an interior surface and an exterior surface opposite the interior surface. The system further includes a holographic film positioned between the light source and the interior surface. The light source may be positioned parallel to the holographic film.

Also disclosed are methods for displaying light from a light source on a display portion of an article, the article defining a receiving portion comprising a holographic film.

In one example, the method includes transmitting light from the light source to the receiving portion of the article and directing the light to the display portion of the article. In one example, the directing includes bending the light at an average projection angle between about 10° and 80°.

In one example, the light may be transmitted at an average receiving angle that is perpendicular to the receiving portion of the article. In another example, the average projection angle may be offset from the average receiving angle.

Other examples will become apparent from the following detailed description, the accompanying drawings, and the appended claims.

### BRIEF DESCRIPTION OF THE DRAWINGS

The disclosure will be described with reference to the following drawing figures wherein like reference numbers identify like parts throughout.

FIG. 1A is a cross-sectional schematic of an article;

FIG. 1B is a cross-sectional schematic of an article;

FIG. 2A is a cross-sectional schematic of an article;

FIG. 2B is a cross-sectional schematic of an article;

FIG. 2C is a cross-sectional schematic of an article;

FIG. 2D is a cross-sectional schematic of an article;

FIG. 3 is a block diagram of a system for directing light through an article; and

FIG. 4 is a flowchart of a method for displaying light from a light source on a display portion of an article

### DETAILED DESCRIPTION OF THE INVENTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

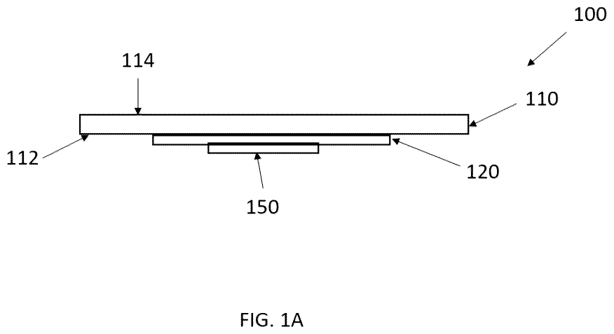

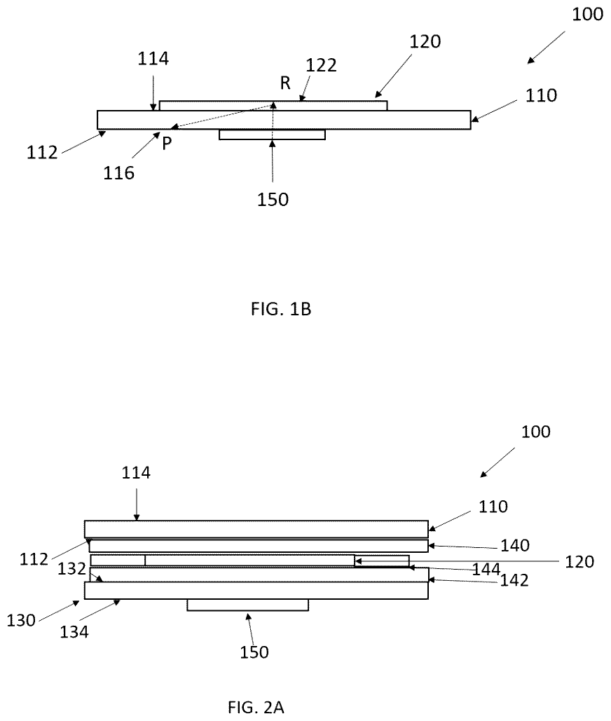

Referring to FIGS. 1A and 1B, disclosed is an article 100. The disclosed article 100 is configured for transmitting or bending and redirecting reflected light. The article 100 may be an automotive component, such as a windshield, a rear window, a brake light, or a headlight. In another example, the article 100 may be an architectural structure.

The article 100 includes a first transparent structure 110 having an interior surface 112 and an exterior surface 114 opposite the interior surface 112. The first transparent structure 110 may be comprised of any suitable material for the intended application. In one example, the first transparent structure 110 comprises a polymer. In another example, the first transparent structure 110 comprises glass, such as a soda-lime-silicate glass, borosilicate glass, or leaded glass. In yet another example, the first transparent structure 110 comprises a tempered glass.

Still referring to FIG. 1A and 1B, in one or more examples, the article 100 further includes a holographic element, such as a holographic film 120 positioned adjacent to one of the interior surface 112 or the exterior surface 114. In one example, the holographic film 120 is coupled with the interior surface 112 of the article 100. The holographic film 120 may be configured to receive light at an average receiving angle R and reflect the light at an average projection angle P that is offset from the average receiving angle R. In one example, the average receiving angle R is substantially perpendicular to the holographic film 120 such that a light source 150 projects light at the holographic film 120 at an average angle that is substantially perpendicular to the holographic film 120, see FIG. 1B. It is understood that the average receiving angle R is an average of the angles of a plurality of light waves that may be scattered at various angles. Similarly, the average projection angle P is an average of the angles of a plurality of light waves that may be scattered at various angles.

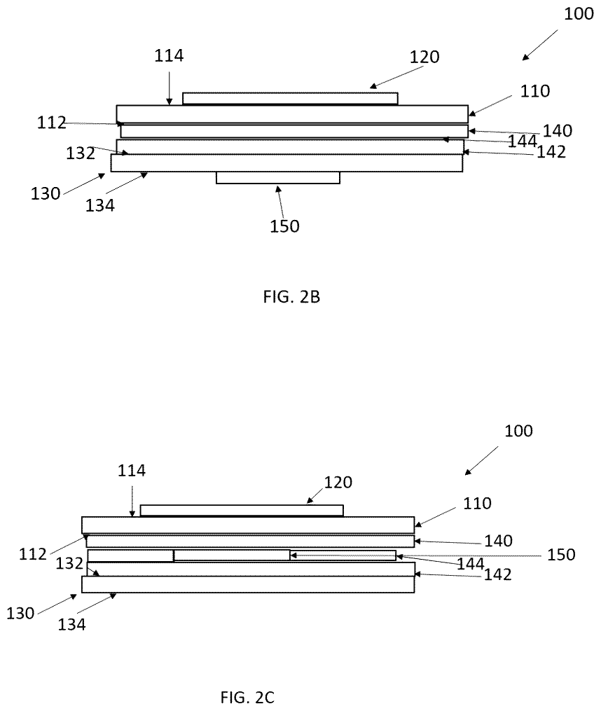

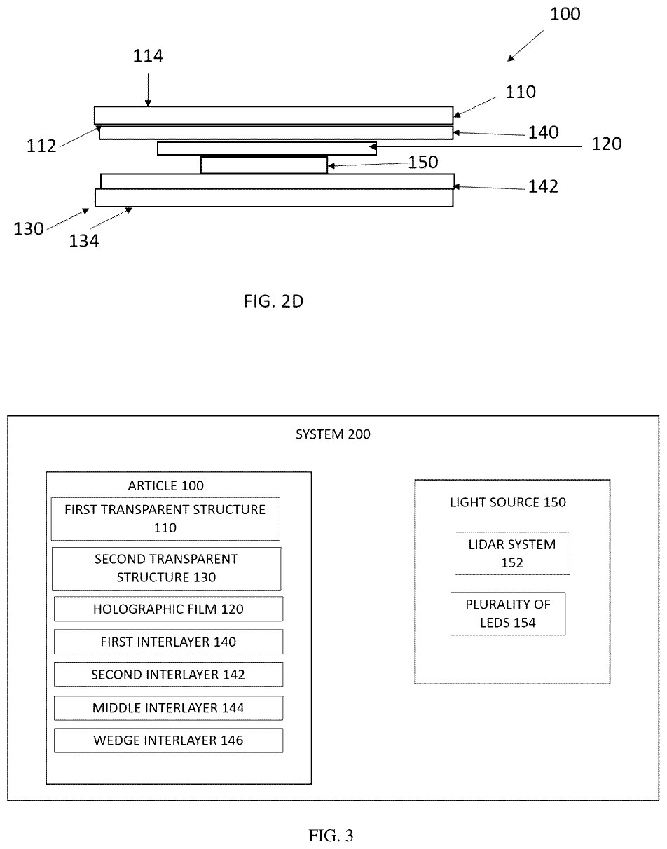

Referring to FIGS. 2A, 2B, 2C, and 2D, in one or more examples, the article 100 may be a laminated structure such that it further includes a second transparent structure 130 having an interior surface 132 and an exterior surface 134 opposite the interior surface 132. The second transparent structure 130 may be comprised of any suitable material for the intended application, and may be comprised of the same material as the first transparent structure 110. In one example, the second transparent structure 130 comprises a polymer. In another example, the second transparent structure 130 comprises glass, such as a soda-lime-silicate glass, borosilicate glass, or leaded glass. In yet another example, the first transparent structure 110 comprises a tempered glass. The interior surface 132 of the second transparent structure 130 may be positioned adjacent to the holographic film 120 and opposed from the first transparent structure 110.

In one non-limiting example, the first transparent structure 110 of the article 100 is a first glass substrate having a No. 1 surface 114 and a No. 2 surface 112 opposite the No. 1 surface 114 and the second transparent structure 130 is a second glass substrate opposed from the first glass substrate or transparent structure 110. The second glass substrate has a No. 3 surface 132 that faces towards the No. 2 surface 112, and a No. 4 surface 134 opposite the No. 3 surface 132. The article 100 further includes a holographic film 120. In one example, the holographic film 120 is positioned between the No. 2 surface 112 of the first glass substrate and the No. 3 surface 132 of the second glass substrate 130. In another example, the holographic film 120 is positioned on the No. 1 surface 114 of the first glass substrate.

Referring to FIGS. 1A, 1B, and FIGS. 2A-2D, in one or more examples, the article 100 further includes a light source 150. As shown in FIGS. 1A and 1B, the light source 150 may be positioned adjacent to the first transparent structure 110. For example, the light source 150 may be positioned adjacent to or be coupled to a single pane first transparent structure 110, such as a tempered glass. In another example, as shown in FIGS. 2C and 2D, the light source 150 may be positioned between the first transparent structure 110 and the second transparent structure 130. In another example, as shown in FIGS. 2A and 2B, the light source 150 is positioned on or adjacent the exterior surface 134 of the second transparent structure 130. In yet another example, the light source 150 is positioned on or adjacent the No. 4 surface 134 of the second glass substrate 130.

The light source 150 may include any means of providing light to be reflected onto the article 100 via the holographic film 120. In one example, the light source 140 includes a plurality of LEDs 154, such as microLEDs. In another example, the light source 150 includes a LIDAR system 152 having at least one laser.

Referring to FIGS. 2A-2D, the article 100, such as a laminate, may further include one or more adhesives or interlayers, such as PVB, polyurethane, or a UV curing, optically clear adhesive. In one example, the article 100 includes a first interlayer 140 positioned between the No. 2 surface and the holographic film 120 and a second interlayer 142 positioned between the No. 3 surface 132 and the holographic film 120. The article 100 may further include a middle interlayer 144 having an opening configured to receive an object, such as the holographic film 120, additional light sources 150, such as microLEDs, or any other object. In yet another example, the article 100 may further include a wedge interlayer 146, such as in a HUD windshield, see FIG. 3.

As disclosed above, the article 100 may be configured in various arrangements based upon the type of light source 150 used, the intended application for the article 100 (windshield, sidelight, rear window, etc.). The following are non-limiting examples of arrangements for the article 100 based upon the type of light source 150 used.

In one example, FIG. 1A may be exemplary of an article 100 having a first transparent structure 110 comprised of a tempered glass. The light source 150 may be a plurality of LEDs 154 having visible lighting. The holographic film 120 is positioned on the inside surface 112 or No. 2 surface of the first transparent structure 110 and the light source 150 is positioned against the holographic film 120.

FIG. 1B illustrates another example of the article 100 having a configuration such that the first transparent structure 110 is comprised of a tempered glass. The light source 150 may be a plurality of LEDs 154 having visible lighting. The holographic film 120 is positioned on the exterior surface 114 or No. 1 surface of the first transparent structure 110 and the light source 150 is positioned against the interior surface 112 or No. 2 surface of the first transparent structure 110.

FIG. 2A illustrates another example of the article 100 having a laminated configuration. The article 100 includes a first transparent structure 110, a second transparent structure 130, a holographic film 120 positioned between the No. 2 surface or inside surface 112 of the first transparent structure 110 and the No. 3 surface or inside surface 132 of the second transparent structure. The light source 150 is positioned on the No. 4 surface or exterior surface 134 of the second transparent structure 130. The light source 150 may be a plurality of LEDs 154 or a LIDAR system 152.

FIG. 2B illustrates another example of the article 100 having a laminated configuration. The article 100 includes a first transparent structure 110, a second transparent structure 130, and a holographic film 120 positioned on the No. 1 surface or exterior surface 114 of the first transparent structure 110. The light source 150 is positioned on the No. 4 surface or exterior surface 134 of the second transparent structure 130. The light source 150 may be a plurality of LEDs 154 or a LIDAR system 152.

FIG. 2C illustrates another example of the article 100 having a laminated configuration. The article 100 includes a first transparent structure 110, a second transparent structure 130, and a holographic film 120 positioned on the No. 1 surface or exterior surface 114 of the first transparent structure 110. The light source 150 is positioned between the No. 2 surface or interior surface 112 of the first transparent structure and the No. 3 surface or interior surface 132 of the second transparent structure 130. The light source 150 may be a plurality of LEDs 154 or a LIDAR system 152.

FIG. 2D illustrates another example of the article 100 having a laminated configuration. The article 100 includes a first transparent structure 110, a second transparent structure 130, a holographic film 120 positioned between the No. 2 surface or inside surface 112 of the first transparent structure 110 and the No. 3 surface or inside surface 132 of the second transparent structure. The light source 150 is positioned between the No. 2 surface or inside surface 112 of the first transparent structure 110 and the No. 3 surface or inside surface 132 of the second transparent structure. The light source 150 may be a plurality of LEDs 154 or a LIDAR system 152.

Referring to FIG. 3, the article 100 may further include a back substrate 148 coupled to one or more of the No. 2 surface or interior surface 112 of the first transparent structure 110 and the No. 4 surface or interior surface 134 of the second transparent structure 130. In one example, the back substrate 148 comprises black paint.

Still referring to FIG. 3, also disclosed is a system 200 for directing light through an article 100. In one example, the system 200 is configured to direct light through the article 100 by transmitting light through the article 100. In another example, the system 200 is configured to direct light through the article by redirecting light received at a first average angle and reflecting at a second average angle that is different from the first average angle.

The system 200 includes a light source 150 and an article 100 positioned relative to the light source 150. The article 100 of the system 200 includes a first transparent structure 110 having an interior surface 112 and an exterior surface 114 opposite the interior surface 112, and a holographic film 120 positioned between the light source 150 and the interior surface 112. In one example, the light source 150 is positioned parallel to the holographic film 120.

In one example, the light source 150 emits light at an average receiving angle that is perpendicular to the holographic film 120. In another example, the light source 150 may include a LIDAR system 152. In yet another example, the light source includes a plurality of LEDs 154. The light source may be configured to emit light having a wavelength within the infrared light spectrum.

The holographic film 120 of the system 200 may define a receiving portion 122 on the article 100 configured to receive light at an average receiving angle R and reflect, by bending and/or redirecting, or direct the light at an average projection angle P. For example, the holographic film 120 of the system 200 is configured to receive light at an average receiving angle R and reflect the light at an average projection angle P. In one example, the average projection angle is P offset from the average receiving angle R.

The article 100 of the system 200 may further include a second transparent structure 130 and may be arranged such that the light source 150 is positioned between the first transparent structure 110 and the second transparent structure 120.

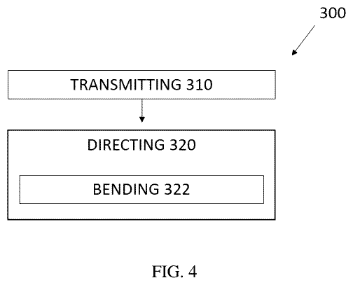

Referring to FIG. 4, also disclosed is a method 300 for displaying light from a light source 150 on a display portion 116 of an article 100 as shown and described herein, the article 100 defining a receiving portion 122 comprising a holographic film 120, see FIG. 1B. In one or more examples, the method 300 includes transmitting 310 light from the light source 150 to the receiving portion 122 of the article 100. In one example, the light is transmitted at an average receiving angle R. The average receiving angle R may be perpendicular to the receiving portion 122 of the article 100. In another example, the average receiving angle R may be between about 50° to about 90° relative to the receiving portion 122 of the article 100.

Still referring to FIG. 4, the method 300 further includes directing 320 the light to the display portion 116 of the article 100. In one example, the directing includes bending 322 the light at an average projection angle P between about 10° and 80°, which is relative to a line parallel to the projection, see FIG. 1B. In another example, the average projection angle P is offset from the average receiving angle R. The light may be directed such that it forms a message in the form of an image or text on the display portion 116 of the article 100. The message may be visible to the driver of the vehicle, to people outside of the vehicle to convey a signal to them, such as breaking, turning, etc., or may be visible to both the driver of the vehicle and those outside of the vehicle.

In one example, the light source 150 of the method 300 is positioned parallel to the article 100. In another example, the light source 150 emits light having a wavelength within the infrared light spectrum. In yet another example, the light source 150 emits light having a wavelength within the ultraviolet light spectrum.

This disclosure is further described in the following numbered clauses:

Clause 1. An article comprising: a first transparent structure comprising an interior surface and an exterior surface opposite the interior surface; and a holographic film positioned adjacent to one of the interior surface or the exterior surface.

Clause 2. The article of clause 1, wherein the holographic film is coupled with the interior surface.

Clause 3. The article of any one of clauses 1-2, wherein the holographic film is configured to receive light at an average receiving angle and reflect the light at an average projection angle that is offset from the average receiving angle.

Clause 4. The article of any one of clauses 1-3, wherein the average receiving angle is substantially perpendicular to the holographic film.

Clause 5. The article of any one of clauses 1-4, wherein the first transparent structure comprises a polymer.

Clause 6. The article of any one of clauses 1-4, wherein the first transparent structure comprises glass.

Clause 7. The article of any one of clauses 1-6, further comprising a light source positioned adjacent to the first transparent structure.

Clause 8. The article of any one of clauses 1-7, further comprising a second transparent structure comprising an interior surface and an exterior surface opposite the interior surface, the interior surface positioned adjacent to the holographic film and opposed from the first transparent structure.

Clause 9. The article of clause 8, further comprising a light source positioned between the first transparent structure and the second transparent structure.

Clause 10. The article of clause 9, wherein the light source comprises a plurality of LEDs.

Clause 11. The article of any one of clauses 8-10, wherein: the first transparent structure is a first glass substrate comprising a No. 1 surface and a No. 2 surface opposite the No. 1 surface; the second transparent structure a second glass substrate opposed from the first glass substrate, wherein the second glass substrate comprises a No. 3 surface that faces towards the No. 2 surface, and a No. 4 surface opposite the No. 3 surface; and the holographic film is positioned between the first glass substrate and the second glass substrate.

Clause 12. The article of any one of clauses 8-11, further comprising at least one of the following: a first interlayer positioned between the No. 2 surface and the holographic film; and a second interlayer positioned between the No. 3 surface and the holographic film.

Clause 13. The article of any one of clauses 8-12, further comprising a middle interlayer comprising an opening configured to receive the holographic film.

Clause 14. The article of any one of clauses 8-13, further comprising a wedge interlayer.

Clause 15. The article of any one of clauses 8-14, further comprising a back substrate coupled to one or more of the No. 2 surface and the No. 4 surface.

Clause 16. The article of clause 15, wherein the back substrate comprises black paint.

Clause 17. The article of any one of clauses 1-16, wherein the article is an automotive component.

Clause 18. The article of any one of clauses 1-17, wherein the article is a windshield.

Clause 19. The article of any one of clauses 1-17, wherein the article is a rear window.

Clause 20. The article of any one of clauses 1-17, wherein the article is a brake light.

Clause 21. The article of any one of clauses 1-17, wherein the article is a headlight.

Clause 22. A system for directing light through an article, the system comprising: a light source; an article positioned relative to the light source, the article comprising a first transparent structure comprising an interior surface and an exterior surface opposite the interior surface; and a holographic film positioned between the light source and the interior surface.

Clause 23. The system of clause 22, wherein the light source is positioned parallel to the holographic film.

Clause 24. The system of any one of clauses 22-23, wherein the article comprises a second transparent structure and wherein the light source is positioned between the first transparent structure and the second transparent structure.

Clause 25. The system of any one of clauses 22-24, wherein the light source emits light at an average receiving angle that is perpendicular to the holographic film.

Clause 26. The system of any one of clauses 22-25, wherein the light source comprises a LIDAR system.

Clause 27. The system of any one of clauses 22-25, wherein the light source comprises a plurality of LEDs.

Clause 28. The system of any one of clauses 22-27, wherein the light source emits light having a wavelength within the infrared light spectrum.

Clause 29. The system of any one of clauses 22-28, wherein the holographic film is configured to receive light at an average receiving angle and reflect the light at an average projection angle that is offset from the average receiving angle.

Clause 30. A method for displaying light from a light source on a display portion of an article, the article defining a receiving portion comprising a holographic film, the method comprising: transmitting light from the light source to the receiving portion of the article; and directing the light to the display portion of the article.

Clause 31. The method of clause 30, wherein the light is transmitted at an average receiving angle that is perpendicular to the receiving portion of the article.

Clause 32. The method of any one of clauses 30-31, wherein the directing comprising bending the light at an average projection angle between about 10° and 80°.

Clause 33. The method of any one of clauses 30-32, wherein the average projection angle is offset from the average receiving angle.

Clause 34. The method of any one of clauses 30-33, wherein the article comprises a first transparent structure comprising an interior surface and an exterior surface opposite the interior surface, and wherein the holographic film is positioned adjacent to the interior surface

Clause 35. The method of any one of clauses 30-34, further comprising a second transparent structure comprising an interior surface and an exterior surface opposite the interior surface, the interior surface positioned adjacent to the holographic film and opposed from the first transparent structure.

Clause 36. The method of clause 35, wherein: the first transparent structure is a first glass substrate comprising a No. 1 surface and a No. 2 surface opposite the No. 1 surface; the second transparent structure a second glass substrate opposed from the first glass substrate, wherein the second glass substrate comprises a No. 3 surface that faces towards the No. 2 surface, and a No. 4 surface opposite the No. 3 surface; and the holographic film is positioned between the first glass substrate and the second glass substrate.

Clause 37. The method of any one of clauses 30-36, wherein the light source is positioned parallel to the article.

Clause 38. The method of any one of clauses 30-37, wherein the light source emits light having a wavelength within the infrared light spectrum.

Clause 39. The method of any one of clauses 30-38, wherein the light source comprises a LIDAR system.

Clause 40. The method of any one of clauses 30-39, wherein the article is an automotive component.

Clause 41. The method of any one of clauses 30-40, wherein the article is a windshield.

Clause 42. The method of any one of clauses 30-40, wherein the article is a brake light.

Clause 43. The method of any one of clauses 30-40, wherein the article is a headlight.

It will be readily appreciated by those skilled in the art that modifications may be made to the disclosure without departing from the concepts disclosed in the foregoing description. Accordingly, the particular examples described in detail herein are illustrative only and are not limiting to the scope of the disclosure, which is to be given the full breadth of the appended claims and any and all equivalents thereof.

What is claimed is:

1. An article comprising:
a first transparent structure comprising an interior surface and an exterior surface opposite the interior surface; and
a holographic film positioned adjacent to one of the interior surface or the exterior surface.

2. The article of claim 1, wherein the holographic film is coupled with the interior surface.

3. The article of claim 1, wherein the holographic film is configured to receive light at an average receiving angle and reflect the light at an average projection angle that is offset from the average receiving angle.

4. The article of claim 3, wherein the average receiving angle is substantially perpendicular to the holographic film.

5. The article of claim 1, wherein the first transparent structure comprises a polymer.

6. The article of claim 1, wherein the first transparent structure comprises glass.

7. The article of claim 1, further comprising a light source positioned adjacent to the first transparent structure.

8. The article of claim 1, further comprising a second transparent structure comprising an interior surface and an exterior surface opposite the interior surface, the interior surface positioned adjacent to the holographic film and opposed from the first transparent structure.

9. The article of claim 8, further comprising a light source positioned between the first transparent structure and the second transparent structure.

10. The article of claim 9, wherein the light source comprises a plurality of LEDs.

11. The article of claim 8, wherein:
the first transparent structure is a first glass substrate comprising a No. 1 surface and a No. 2 surface opposite the No. 1 surface;
the second transparent structure a second glass substrate opposed from the first glass substrate, wherein the second glass substrate comprises a No. 3 surface that faces towards the No. 2 surface, and a No. 4 surface opposite the No. 3 surface; and
the holographic film is positioned between the first glass substrate and the second glass substrate.

12. The article of claim 11, further comprising:
a first interlayer positioned between the No. 2 surface and the holographic film; and
a second interlayer positioned between the No. 3 surface and the holographic film.

13. The article of claim 11, wherein the holographic film is configured to transmit light through the article.

14. The article of claim 11, further comprising a middle interlayer comprising an opening configured to receive the holographic film.

15. The article of claim 11, further comprising a back substrate coupled to the No. 2 surface or the No. 4 surface.

16. The article of claim 15, wherein the back substrate comprises black paint.

17. The article of claim 1, wherein the article is a windshield.

18. The article of claim 1, wherein the article is a rear window.

19. A system for directing light through an article, the system comprising:
a light source;
an article positioned relative to the light source, the article comprising a first transparent structure comprising an interior surface and an exterior surface opposite the interior surface; and
a holographic film positioned between the light source and the interior surface.

20. A method for displaying light from a light source on a display portion of an article, the article defining a receiving portion comprising a holographic film, the method comprising:
transmitting light from the light source to the receiving portion of the article; and
directing the light to the display portion of the article.
